(19) United States
(12) Patent Application Publication
(10) Pub. No.: US 2026/0105826 A1
(43) Pub. Date: Apr. 16, 2026

(54) VEHICULAR CABIN MONITORING SYSTEM WITH UNATTENDED OCCUPANT ALERT

(71) Applicant: Magna Mirrors of America, Inc., Holland, MI (US)

(72) Inventor: Michael J. Baur, Kentwood, MI (US)

(21) Appl. No.: 19/353,709

(22) Filed: Oct. 9, 2025

Related U.S. Application Data
(60) Provisional application No. 63/706,789, filed on Oct. 14, 2024.
(60) Provisional application No. 63/722,109, filed on Nov. 19, 2024.

(51) Int. Cl. G08B 21/02; B60Q 9/00; G08B 21/22; G08B 21/24

(52) U.S. Cl. CPC G08B 21/02; B60Q 9/00; G08B 21/22; G08B 21/24

(57) ABSTRACT

A vehicular cabin monitoring system includes a sensor disposed within an interior cabin of a vehicle. The vehicular cabin monitoring system, via processing of sensor data captured by the sensor, is operable to determine presence of an occupant within the interior cabin of the vehicle. An informational display device is disposed at a forward portion of a mirror casing of an interior rearview mirror assembly of the vehicle. The informational display device, when electrically operated, displays an informational alert that is viewable exterior the vehicle. The vehicular cabin monitoring system, based on determination that the vehicle is parked and no driver is present within the interior cabin of the vehicle, and responsive to determining presence of the occupant within the interior cabin of the vehicle, operates the informational display device to display the informational alert.

### CROSS REFERENCE TO RELATED APPLICATIONS

The present application claims the filing benefits of U.S. provisional application Ser. No. 63/722,109, filed Nov. 19, 2024, and U.S. provisional application Ser. No. 63/706,789, filed Oct. 14, 2024, which are hereby incorporated herein by reference in their entireties.

### FIELD OF THE INVENTION

The present invention relates generally to a vehicular cabin monitoring system for a vehicle and, more particularly, to a vehicular cabin monitoring system that utilizes one or more sensors at a vehicle.

### BACKGROUND OF THE INVENTION

It is known to provide a mirror assembly that is adjustably mounted to an interior portion of a vehicle, such as via a double ball pivot or joint mounting configuration where the mirror head and reflective element are adjusted relative to the interior portion of a vehicle by pivotal movement about the double ball pivot configuration. The mirror head and reflective element are pivotable about either or both of the ball pivot joints by a user that is adjusting the user's rearward view.

### SUMMARY OF THE INVENTION

A vehicular cabin monitoring system of a vehicle includes a sensor disposed within an interior cabin of a vehicle equipped with the vehicular cabin monitoring system, such as a camera, a radar sensor, an ultrasonic sensor and the like. The sensor senses within the interior cabin of the vehicle. An electronic control unit (ECU) includes electronic circuitry and associated software, and the electronic circuitry of the ECU includes a processor operable to process sensor data captured by the sensor and transferred to the ECU. The vehicular cabin monitoring system, via processing at the ECU of sensor data captured by the sensor, determines presence of occupants within the interior cabin of the vehicle. A display device is disposed at a structure of the vehicle, and the display device, when electrically operated, displays an alert that is viewable exterior the vehicle. The vehicular cabin monitoring system, based on determination that the vehicle is parked and the driver is absent from the vehicle, and responsive to determining presence of an occupant within the interior cabin of the vehicle, operates the display device to display the alert.

These and other objects, advantages, purposes and features of the present invention will become apparent upon review of the following specification in conjunction with the drawings.

### BRIEF DESCRIPTION OF THE DRAWINGS

FIG. 1 is a side view of a vehicle having a vehicular cabin monitoring system;

FIG. 2 is a perspective view of an interior rearview mirror assembly of the vehicle having display devices at a mirror casing of the interior rearview mirror assembly;

FIG. 3 is a perspective view of the vehicle, with the display devices providing an illuminated alert that is viewable through the windshield of the vehicle;

FIG. 4 is a schematic view of a display device disposed at or near a windshield electronics module of the vehicle;

FIG. 5 is a perspective view of an exterior rearview mirror assembly of the vehicle having indicator devices at a mirror casing and a mounting base of the exterior rearview mirror assembly;

FIG. 6 shows a projection device projecting an image onto a vehicular glass surface where the image is viewable at both sides of the glass;

FIG. 7 is a schematic view of projection devices disposed at the exterior rearview mirror assemblies of the vehicle for projecting images onto interior surfaces of the vehicular windows;

FIG. 8 is a schematic view of projection devices disposed at the exterior rearview mirror assemblies of the vehicle for projecting images onto exterior surfaces of the vehicle; and

FIG. 9 is a schematic view of projection devices disposed at the interior rearview mirror assembly of the vehicle for projecting images onto interior surfaces and exterior surfaces of the vehicle.

### DESCRIPTION OF THE PREFERRED EMBODIMENTS

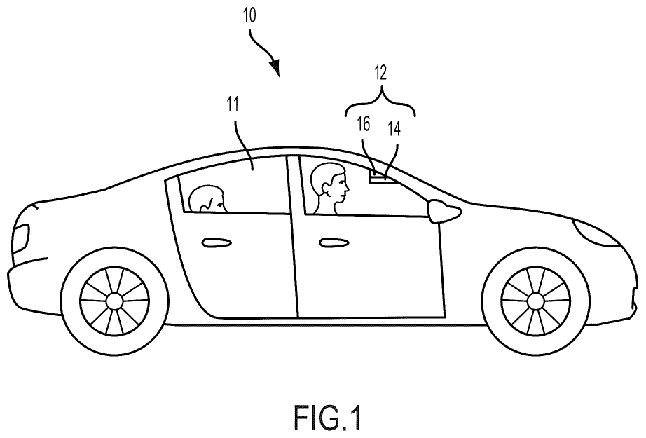

Referring now to the drawings and the illustrative embodiments depicted therein, a vehicular cabin monitoring system 12 for a vehicle 10 is configured to detect presence of occupants within an interior cabin 11 of the vehicle 10 and generate an alert responsive to detecting presence of occupants when the vehicle 10 is parked and/or in an off state (FIG. 1). The cabin monitoring system 12 includes one or more sensors or sensing devices 14 within the interior cabin 11 of the vehicle that sense respective regions or portions of the interior cabin 11. The system 12 further includes a control or electronic control unit (ECU) 16 that includes electronic circuitry and associated software, such as a data processor or image processor for processing sensor data captured by the one or more sensors 14, whereby the ECU 16 may detect or determine presence of objects, occupants and the like within the cabin 11 of the vehicle 10. Although shown as disposed at an overhead console module of the vehicle 10, it should be understood that the one or more sensors 14 and/or the ECU 16 may be disposed at any suitable portion of the interior cabin 11 of the vehicle 10 for sensing regions of the interior cabin 11, such as at an interior rearview mirror assembly, a light module (e.g., a reading light or dome light), a grab handle module, and/or at or behind the vehicle headliner. The data transfer or signal communication from the one or more sensors 14 to the ECU 16 may comprise any suitable data or communication link, such as a vehicle network bus or the like of the equipped vehicle.

The one or more sensors 14 may include any suitable type of sensor or combination of types of sensors, such as a camera that views within the interior cabin 11 of the vehicle 10 and that captures image data, an infrared camera module that emits infrared or near infrared light and that views within the interior cabin 11 of the vehicle 10 and captures image data representative of infrared or near infrared light, or an ultrasonic sensor or radar sensor that senses within the interior cabin 11 of the vehicle and that captures sensor data. The sensor 14 may be positioned at an elevated position within the cabin 11 of the vehicle (e.g., at the interior rearview mirror or at or behind the vehicle headliner) to sense portions of the interior cabin with limited to no obstructions. Optionally, a plurality of sensors 14 may be positioned at various positions within the cabin 11 to provide full sensing coverage.

The system 12 determines presence of occupants within the interior cabin 11 of the vehicle 10 via processing of sensor data captured by the one or more sensors 14 immediately preceding and/or immediately following the vehicle 10 being parked and/or turned off (e.g., a propulsion system of the vehicle is adjusted to a parking state and/or the propulsion system is adjusted to an off state, such as by switching the ignition to an off state and/or a gear selector of the vehicle is moved to a parking gear) to monitor for unattended occupants (e.g., children and/or pets) that are or may be left behind in the vehicle 10. For example, the system 12 may determine presence of occupants within the cabin 11 of the vehicle 10 based on detecting movement within the cabin of the vehicle after the vehicle is parked. In some examples, the system 12 may be sensitive enough to detect millimeter-level movements, such as movement caused by an occupant breathing.

In some examples, the system 12 may determine presence of occupants within the interior cabin 11 of the vehicle 10 in response to determination that the vehicle 10 has been parked and/or turned off and that the driver of the vehicle 11 has exited the vehicle 10. To determine that an occupant has been left behind in the cabin 11 of the vehicle 10, the system may capture and process sensor data for a threshold period of time after determining that a driver has exited the vehicle 10, such as for one minute, five minutes, ten minutes and the like. For example, the system 12 may determine that the driver has exited the vehicle based on a signal from a driver monitoring system (DMS) of the vehicle and/or processing of sensor data captured by the DMS camera and/or from processing of sensor data captured by an occupant monitoring camera that views within the interior cabin of the vehicle. Optionally, the system 12 may determine that the driver has exited the vehicle based on the vehicle being parked and/or turned off and the driver door opening and closing and/or the vehicle doors being adjusted to a locked state. The system 12 may determine that the driver has exited the vehicle based on detecting that a key fob associated with the vehicle 10 is exterior of the vehicle. Further, the system 12 may determine that the driver has exited the vehicle based on a sensor at the driver seat (e.g., a weight sensor) detecting that the driver seat is unoccupied. In some examples, the system 12 may periodically or episodically operate the sensor 14 and process captured sensor data to scan for occupants within the vehicle 10, such as every 10 minutes, every 30 minutes, every hour, and the like. Thus, the system 12 provides a low power system for detecting unattended occupants left behind in the vehicle.

Based on determining that an occupant has been left behind in the cabin 11 of the vehicle 10, the system 12 generates an alert to the driver of the vehicle. The system 12 may generate the alert after a threshold period of time has passed with the occupant remaining in the cabin of the vehicle (e.g., a threshold period of one minute, five minutes, ten minutes and the like). For example, the system 12 may generate an alert at a mobile device associated with the driver of the vehicle (e.g., via a mobile application associated with the vehicle, via a text message, via an automated phone call, and the like). Further, the system 12 may generate an alert at the vehicle 10, such as by honking a horn of the vehicle or playing an audio tone or message, flashing or illuminating lights of the vehicle (e.g., headlights, hazard lights, turn signal indicators, and the like), and the like. Optionally, the system 12 may generate progressive alerts, such as by generating a first alert (e.g., flashing lights) after a first threshold period of time has passed (e.g., one minute), generating a second alert (e.g., playing an audio tone) after a second threshold period of time has passed (e.g., two minutes), and generating a third alert (e.g., generating an alert at a mobile device of the driver) after a third threshold period of time has passed (e.g., five minutes).

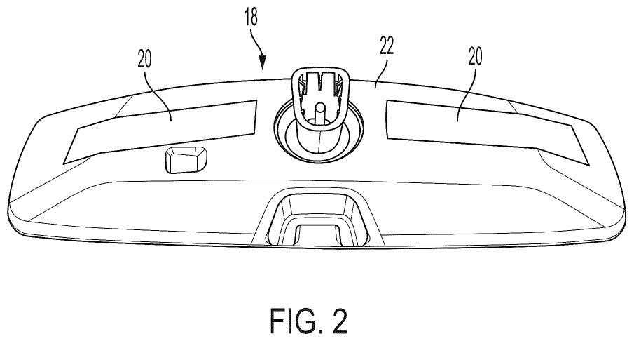

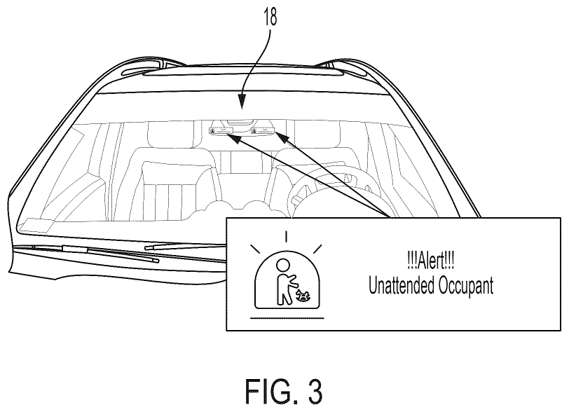

In some examples, the system 12 may generate an alert that is viewable to a person exterior the vehicle, such as to alert a passerby that an occupant has been left unattended in the vehicle 10. For example, and referring to FIGS. 2 and 3, an interior rearview mirror assembly 18 of the vehicle 10 may include one or more actuatable displays 20 that are viewable exterior of the vehicle 10, such as through a windshield of the vehicle 10. In the illustrated example, the displays 20 include backlit icons or display screens that, when illuminated, display a warning message or alert message or informational alert to viewers outside of the vehicle. The informational alert comprises information interpretable by a person viewing the alert from exterior the vehicle that an occupant or child is within the interior cabin of the vehicle. The message or alert may include information related to the unattended occupant (i.e., a message stating that an unattended occupant is left in the vehicle) to alert the viewer as to the situation causing the message. Optionally, the display 20 may comprise a configurable display for displaying different messages and/or icons or alerts. Optionally, the informational display or alert may comprise an SOS display or representation or an icon/representation of a person or child, optionally with or without text that provides additional information.

The display or icon 20 may be disposed at or integrally formed with a casing 22 of the mirror head of the interior rearview mirror assembly 18. Optionally, the display 20 may be rendered covert or hidden when not being illuminated to provide the alert. For example, the display 20 may be disposed at the exterior surface of the casing 22 and at least partially transparent to visible light incident at the display 20 when not being operated so that a person viewing the mirror head casing 22 would at least partially view the casing through the display 20. Optionally, the display 20 may be substantially darkened or dimmed or not illuminated when the alert is not being generated so that the display 20 substantially blends in or appears similar to a dark exterior surface of the casing 22. Thus, the display 20 provides a backlit warning sign for an unattended child alert (or other condition) when the vehicle alarm is actuated. The display 20 may be covert to provide display on demand. Thus, the display 20 illuminates upon fault detection.

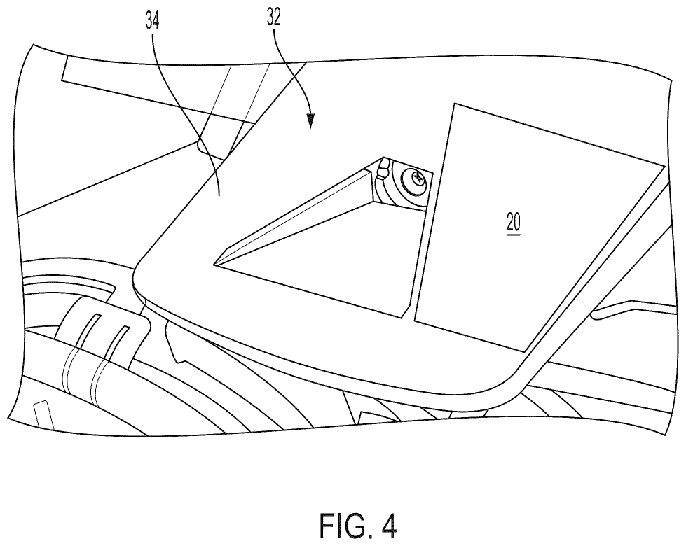

One or more displays 20 may be disposed at other components within the cabin of the vehicle and viewable exterior of the vehicle through the windshield and/or windows of the vehicle. For example, and as shown in FIG. 4, a windshield mounted electronics module (WEM) 32 may include or accommodate one or more displays 20 viewable through the windshield of the vehicle. In the illustrated example, the WEM 32 is disposed at the windshield so that one or more sensors and/or cameras of the WEM 32 view through an aperture in an opaque or substantially opaque or hiding layer 34 at the windshield. The display 20 may be accommodated within a housing of the WEM 32 and viewable through another aperture in the hiding layer 34 when electrically operated to provide the alert. Optionally, the display 20 may be rendered covert when not operated to provide the alert and generally correspond to the appearance of the hiding layer 34. For example, the display 20 may be disposed behind the hiding layer, such as behind a portion of the hiding layer that is at least partially light transmissive, and viewable through the hiding layer when electrically operated. Optionally, the display 20 may be substantially darkened or dimmed or not illuminated when the alert is not being generated so that the display 20 substantially blends in or appears similar to the dark hiding layer 34.

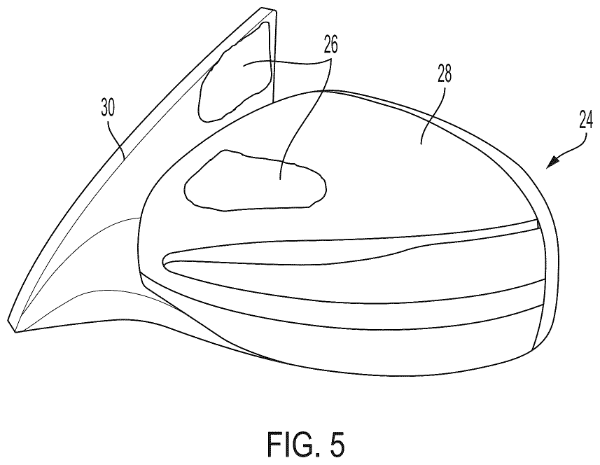

As shown in FIG. 5, an exterior rearview mirror assembly 24 at one or both sides of the vehicle 10 may include one or more indicator devices 26, such as a display device or light module or illuminable icon, that is operable to provide the alert. In the illustrated example, the exterior rearview mirror assembly 24 includes one indicator device 26 at a mirror head casing 28 of the mirror assembly 24 and another indicator device 26 at a mounting arm or mounting base 30 of the mirror assembly 24. It should be understood that indicator devices may be disposed at any exterior portion of the mirror assembly 24, or at any suitable exterior component of the vehicle, such as a door handle assembly, a spoiler, a door or liftgate, a pillar of the vehicle (e.g., the A-pillar, the B-pillar, the C-pillar and/or the D-pillar) and the like, where the indicator device may be illuminated and readily viewable by a person exterior the vehicle. The indicator device 26, similar to the display 20, may provide a backlit warning sign or configurable display device for providing the alert exterior the vehicle.

Further, the indicator device 26 may be rendered covert when not operated to provide the alert and generally correspond to the appearance of the exterior rearview mirror assembly 24 (or other exterior component of the vehicle). For example, the indicator device 26 may be disposed at the exterior surface of the mirror head 28 or mounting base 30 and at least partially transparent to visible light incident at the indicator device 26 when not being operated so that a person viewing the exterior rearview mirror assembly 24 would at least partially view the mirror head 28 or mounting base 30 through the indicator device 26. Optionally, the indicator device 26 may be substantially darkened or dimmed or not illuminated when the alert is not being generated so that the indicator device 26 substantially blends in or appears similar to a dark exterior surface of the mirror head 28 or mounting base 30.

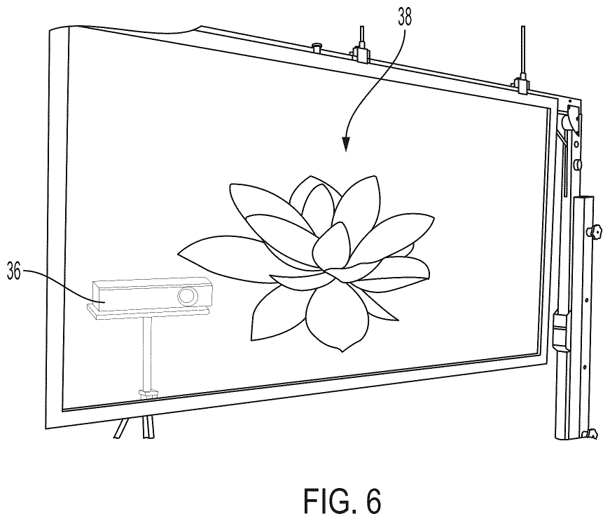

Optionally, the alert may be displayed to viewers exterior the vehicle via a projection device 36 that projects an image 38 onto a surface that is viewable exterior of the vehicle, such as a wall in front of the vehicle, the ground surface surrounding the vehicle, the hood of the vehicle, an interior or exterior surface of the windshield or a window of the vehicle, and the like (FIG. 6). The vehicle glass may be tinted or include an optical film or coating to display the image 38 at the surface of the glass, and to allow the image 38 to be viewable exterior of the vehicle. For example, the vehicle glass may include automotive “Green Glass,” tinted glass, glass having a specialty optical treatment and/or film (e.g., a treatment or film that provides a desired tint or spectral characteristic or color) and the like.

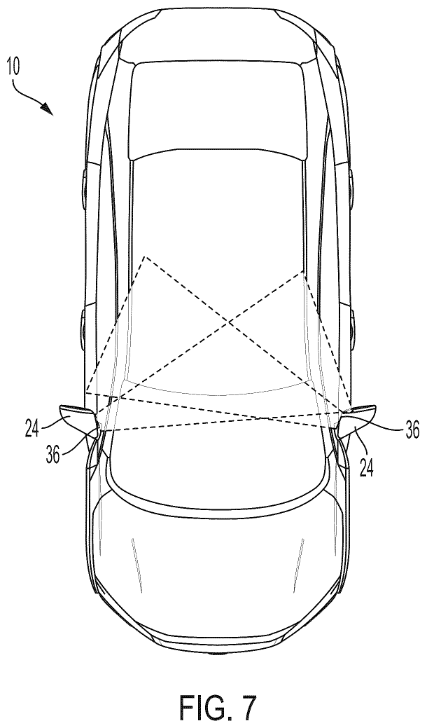

Referring to FIG. 7, the vehicle 10 may include one or more projection devices 36 operable to project alert images onto an interior surface of the windshield or window of the vehicle to be viewed exterior of the vehicle. In the illustrated example, the vehicle 10 includes projection devices 36 at the respective exterior rearview mirror assemblies 24 where each projection device 36 projects an image across the interior cabin of the vehicle 10 to be displayed at the interior surface of the window at the opposite side of the vehicle 10. That is, the projection device 36 projects light through a window at the same side of the vehicle 10 as the projection device 36 so that the image 38 is projected onto the interior surface of the window at the opposing side of the vehicle 10. For example, the window at the same side of the vehicle 10 as the projection device 36 may have a portion that is devoid of the optical treatment or film so that light projected by the projection device 36 passes through that portion of the window and the image 38 is displayed at the window on the opposite side of the vehicle 10 as the projection device 36 at a portion of the window that includes the optical treatment or film. The projected image 38 is then viewable exterior the vehicle 10 at the window at which the image 38 is being displayed.

Optionally, the projection devices 36 may be disposed at an interior portion of the interior cabin 11 of the vehicle for projecting the alert images 38 onto respective interior surfaces of the vehicle glass. For example, the projection device 36 may be disposed at an overhead console module or one or more of the vehicle pillars (e.g., the A-pillar, the B-pillar, the C-pillar and/or the D-pillar). The vehicle pillars may have an unobstructed projection path to the cross-vehicle window. Similarly, projection may be achieved from an upper portion of the door panel or the headliner of the vehicle. Thus, the projection device 36 may project light from within the interior cabin of the vehicle and toward a window or the windshield of the vehicle so that the image 38 is projected onto the interior surface of the window. The projected image 38 is then viewable exterior the vehicle 10 at the window at which the image 38 is being displayed.

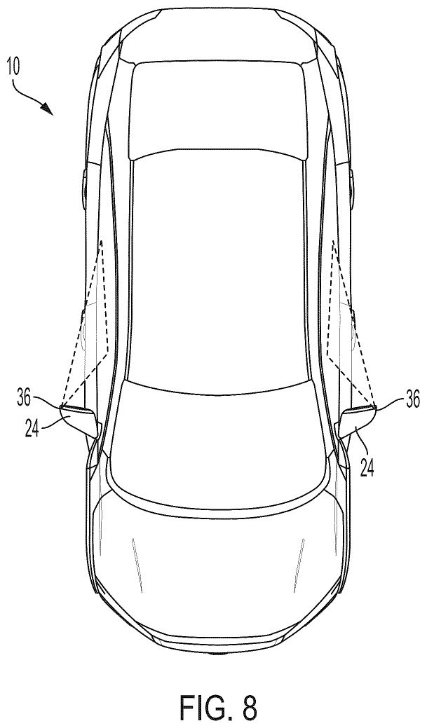

Referring to FIG. 8, the vehicle 10 may include one or more projection devices 36 operable to project alert images onto an exterior surface of the vehicle, such as a body panel (e.g., the vehicle door or hood), the windshield, and/or a window of the vehicle. In the illustrated example, the vehicle 10 includes projection devices 36 at the respective exterior rearview mirror assemblies 24 where each projection device 36 projects an image onto an exterior surface of the vehicle 10 at the respective side of the vehicle 10. Optionally, the projection devices may be disposed at other exterior components for projecting the images onto exterior surfaces of the vehicle 10, such as at a forward portion of the vehicle (e.g., at a hood of the vehicle) for projecting images onto the windshield of the vehicle, at a rearward portion of the vehicle (e.g., at a trunk lid of the vehicle or a spoiler of the vehicle or an upper portion of a liftgate of the vehicle) for projecting images onto the rear window of the vehicle and the like. In some examples, one or more projection devices may be disposed at exterior portions of the vehicle pillars (e.g., the A-pillar, the B-pillar, the C-pillar and/or the D-pillar) for projecting images onto exterior surfaces of the vehicle (e.g., exterior body panels and/or exterior glass surfaces).

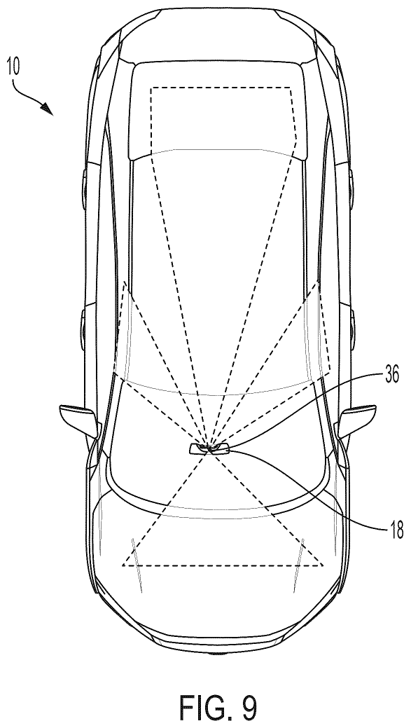

As shown in FIG. 9, the vehicle 10 may include one or more projection devices 36 at an interior portion of the vehicle 10 and operable to project alert images onto an interior surface of the windshield or window of the vehicle 10 and/or an exterior surface of the vehicle. In the illustrated example, the vehicle 10 includes projection devices 36 at the interior rearview mirror assembly 18 operable to project alert images through the windshield and onto the hood of the vehicle, onto the interior surfaces of the side windows of the vehicle, and onto the interior surface of the rear window of the vehicle. Optionally, the projection device 36 projects the alert image through the rear window of the vehicle and onto an exterior surface of the trunk lid of the vehicle 10. For example, portions of the windshield and/or the rear window may be devoid of the optical treatment or film so that light emitted by the projection device 36 may pass through the respective portions of the windshield or rear window and display the image 38 on the hood or trunk lid.

The one or more projection devices 36 may be disposed at any suitable portion of the vehicle. For example, the projection device 36 may be disposed at a rear portion of the interior rearview mirror head that faces the windshield (e.g., for projecting the image onto the hood of the vehicle, onto an interior surface of the windshield and the like), at the exterior rearview mirror head 28 (e.g., for projecting the image onto a wall or other exterior surface in front of the vehicle, onto an exterior surface of a window of the vehicle and the like), at a door handle module of the vehicle (e.g., for providing ground illumination), and the like.

These visual alerts may be combined with an audio alert, such as via an audio device operable to play audio exterior of the vehicle. The audio device may be disposed at the exterior rearview mirror assembly, or at any suitable location of the vehicle. For example, the audio device may be similar to what is used with electric vehicles to emit an audible signal while moving. Thus, the audio device can be used to audibly alert safety and security risks including an unattended child.

Optionally, the visual and/or audible alerts for the unattended occupant (e.g., a child and/or a pet) within the vehicle may be generated as part of an escalating or progressive alert. For example, the system may generate an audible alert responsive to detecting the unattended occupant for a first threshold period of time (e.g., 30 seconds or more), generate a first visual alert (e.g., illuminate the display at the interior rearview mirror assembly and/or the indicator device at the exterior rearview mirror assembly) responsive to detecting the unattended occupant for a second threshold period of time (e.g., 2 minutes or more), generate a second visual alert (e.g., flash the display at the interior rearview mirror assembly and/or the indicator device at the exterior rearview mirror assembly and/or project the alert image onto the surface at or near the vehicle) responsive to detecting the unattended occupant for a third threshold period of time (e.g., 5 minutes or more), and generate both an audible alert and a visual alert responsive to detecting the unattended occupant for a fourth threshold period of time (e.g., 10 minutes or more).

Optionally, the alerts may be generated when a security risk is determined, such as when a vehicle alarm or anti-theft system is triggered. The display 20 and/or indicator device 26 may be configurable to distinguish between an unattended occupant alert and an anti-theft alert.

In some examples, the system 12 may determine presence of the occupant within the interior cabin of the vehicle (e.g., at a rear seating position of the vehicle) and generate an alert or warning in response to the vehicle being parked or turned off, and before the driver exits the vehicle 10. The alert may be viewable by the driver of the vehicle before exiting the vehicle 10 and thus the alert may function as a reminder to remove occupants (e.g., a child or pet) from the rear seat or to allow the rear occupants to exit the vehicle cabin. For example, the alert may include an image projected onto the interior surface of the windshield or the window at the driver door that includes a reminder message (e.g., “Check Back Seats”or “Unlock Rear Doors”).

The display system may utilize aspects of the systems described in U.S. Pat. Nos. 12,304,287 and/or 10,427,503, and/or U.S. Publication No. US-2025-0244646, and/or International Publication No. WO 2025/010215, which are hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or occupants or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect objects and/or occupants. Responsive to such image processing, and when an object or occupant is detected, the system may generate an alert to the driver of the vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the cabin monitoring system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The sensor may include a camera disposed at the mirror head of the interior rearview mirror assembly within the interior cabin of the vehicle and viewing the driver seat region and/or passenger seat regions within the interior cabin of the vehicle. For example, the camera may be disposed within the mirror head and behind the mirror reflective element of the mirror head so as to view through the mirror reflective element (e.g., to view through a transflective mirror reflector of the mirror reflective element). Optionally, the mirror head may accommodate another type of sensor, such as a non-imaging sensor or radar sensor or ultrasonic sensor or the like. The system may process sensor data captured by the sensor at the mirror head to determine when the driver exits the vehicle and/or to determine if an occupant remains within the interior cabin of the vehicle.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International Publication No. WO 2023/220222 and/or International PCT Application No. PCT/US2025/038021, filed Jul. 17, 2025 (Attorney Docket DON01 FP5398WO), and/or International PCT Application No. PCT/US25/27206, filed May 1, 2025 (Attorney Docket DON01 FP5372WO), which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

Optionally, the display element may comprise any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like.

Optionally, the mirror assembly may include one or more other displays, such as the types disclosed in U.S. Pat. Nos. 5,530,240 and/or 6,329,925, which are hereby incorporated herein by reference in their entireties, and/or display-on-demand transflective type displays, and/or video displays or display screens, such as the types disclosed in U.S. Pat. No. 8,890,955; 7,855;755; 7,338,177; 7,274,501; 7,255,451; 7,195,381; 7,184,190; 7,046,448; 5,668,663; 5,724,187; 5,530,240; 6,329,925; 6,690,268; 7,734,392; 7,370,983; 6,902,284; 6,428,172; 6,420,975; 5,416,313; 5,285,060; 5,193,029 and/or 4,793,690, and/or in U.S. Pat. Pub. Nos. US-2006-0050018; US-2009-0015736; US-2009-0015736; and/or US-2010-0097469, which are all hereby incorporated herein by reference in their entireties.

The mirror assembly may comprise or utilize aspects of other types of casings or the like, such as described in U.S. Pat. Nos. 7,338,177; 7,289,037; 7,249,860; 6,439,755; 4,826,289 and/or 6,501,387, which are all hereby incorporated herein by reference in their entireties. For example, the mirror assembly may utilize aspects of the flush or frameless or bezelless reflective elements described in U.S. Pat. Nos. 7,626,749; 7,360,932; 7,289,037; 7,255,451; 7,274,501 and/or 7,184,190, which are all hereby incorporated herein by reference in their entireties.

Optionally, the accessory or accessories, such as those described above, may be positioned at or within the mirror casing and/or mirror cap portion or the like, and may be included on or integrated in a printed circuit board positioned within the mirror casing and/or cap portion, such as along a rear surface of the reflective element or elsewhere within a cavity defined by the casing.

Changes and modifications in the specifically described embodiments may be carried out without departing from the principles of the present invention, which is intended to be limited only by the scope of the appended claims as interpreted according to the principles of patent law.

1. A vehicular cabin monitoring system, the vehicular cabin monitoring system comprising:
a sensor disposed within an interior cabin of a vehicle equipped with the vehicular cabin monitoring system, wherein the sensor senses within the interior cabin of the vehicle;
an electronic control unit (ECU);
wherein sensor data captured by the sensor is transferred to the ECU;
wherein the ECU comprises electronic circuitry and associated software, and wherein the electronic circuitry of the ECU comprises a processor operable to process sensor data transferred to the ECU;
wherein the vehicular cabin monitoring system, via processing at the ECU of sensor data captured by the sensor, is operable to determine presence of an occupant within the interior cabin of the vehicle;
an informational display device disposed at an interior rearview mirror assembly of the vehicle, wherein the informational display device, when electrically operated, displays an informational alert that is viewable exterior the vehicle;
wherein the informational display device is disposed at a forward portion of a mirror casing of the interior rearview mirror assembly; and
wherein the vehicular cabin monitoring system, based on determination that the vehicle is parked and no driver is present within the interior cabin of the vehicle, and responsive to determining presence of the occupant within the interior cabin of the vehicle, operates the informational display device to display the informational alert that is viewable exterior the vehicle.

2. The vehicular cabin monitoring system of claim 1, wherein the informational alert is viewable exterior the vehicle through a windshield of the vehicle.

3. The vehicular cabin monitoring system of claim 1, wherein the informational display device comprises a display screen, and wherein the informational alert comprises a message displayed at the display screen that is indicative of presence of the occupant within the interior cabin of the vehicle.

4. The vehicular cabin monitoring system of claim 1, wherein the informational display device comprises a backlit icon, and wherein the informational alert comprises illuminating the backlit icon to be viewable exterior the vehicle.

5. The vehicular cabin monitoring system of claim 1, wherein the informational display device comprises a projector, and wherein the projector, when electrically operated, emits light toward a surface exterior of the vehicle to display the informational alert at the surface.

6. The vehicular cabin monitoring system of claim 5, wherein the surface comprises one selected from the group consisting of (i) a hood of the vehicle, (ii) a vertical wall surface remote from the vehicle and (iii) a ground surface exterior of the vehicle.

7. The vehicular cabin monitoring system of claim 1, wherein the informational alert comprises a progressive informational alert, and wherein the progressive informational alert comprises at least one selected from the group consisting of (i) illuminating the informational display device and (ii) flashing the informational display device.

8. The vehicular cabin monitoring system of claim 1, wherein the vehicular cabin monitoring system, based on determination that the vehicle is parked and no driver is present within the interior cabin of the vehicle, and responsive to determining presence of the occupant within the interior cabin of the vehicle, operates an audio device to play an audible alert exterior the vehicle.

9. The vehicular cabin monitoring system of claim 1, wherein the sensor comprises at least one selected from the group consisting of (i) a camera, (ii) a radar sensor and (iii) an ultrasonic sensor.

10. The vehicular cabin monitoring system of claim 1, wherein the sensor comprises a camera accommodated by a mirror head of the interior rearview mirror assembly.

11. A vehicular cabin monitoring system, the vehicular cabin monitoring system comprising:
a sensor disposed within an interior cabin of a vehicle equipped with the vehicular cabin monitoring system, wherein the sensor senses within the interior cabin of the vehicle;
an electronic control unit (ECU);
wherein sensor data captured by the sensor is transferred to the ECU;
wherein the ECU comprises electronic circuitry and associated software, and wherein the electronic circuitry of the ECU comprises a processor operable to process sensor data transferred to the ECU;
wherein the vehicular cabin monitoring system, via processing at the ECU of sensor data captured by the sensor, is operable to determine presence of an occupant within the interior cabin of the vehicle;
an informational projection device disposed at an exterior portion of the vehicle, wherein the informational projection device, when electrically operated, emits light toward a surface of the vehicle to display an image at the surface, and wherein the image comprises an informational alert that is viewable exterior the vehicle; and
wherein the vehicular cabin monitoring system, based on determination that the vehicle is parked and no driver is present within the interior cabin of the vehicle, and responsive to determining presence of the occupant within the interior cabin of the vehicle, operates the informational projection device to project the informational alert that is viewable exterior the vehicle.

12. The vehicular cabin monitoring system of claim 11, wherein the exterior portion of the vehicle comprises an exterior rearview mirror assembly of the vehicle.

13. The vehicular cabin monitoring system of claim 12, wherein the exterior rearview mirror assembly is disposed at a first side of the vehicle, and wherein the surface comprises an interior surface of a window that is disposed at a second side of the vehicle opposite the first side.

14. The vehicular cabin monitoring system of claim 12, wherein the exterior rearview mirror assembly is disposed at a first side of the vehicle, and wherein the surface comprises an exterior surface of the vehicle at the first side of the vehicle.

15. The vehicular cabin monitoring system of claim 11, wherein the surface comprises an exterior surface of the vehicle, and wherein the exterior surface comprises at least one selected from the group consisting of (i) a window of the vehicle, (ii) a body panel of the vehicle and (iii) a hood of the vehicle.

16. The vehicular cabin monitoring system of claim 11, wherein the exterior portion of the vehicle is disposed at a first side of the vehicle, and wherein the surface comprises an interior surface of a window of the vehicle that is disposed at a second side of the vehicle opposite the first side.

17. The vehicular cabin monitoring system of claim 11, wherein the sensor comprises at least one selected from the group consisting of (i) a camera, (ii) a radar sensor and (iii) an ultrasonic sensor, and wherein the sensor is accommodated by a mirror head of an interior rearview mirror assembly disposed within the interior cabin of the vehicle.

18. A vehicular cabin monitoring system, the vehicular cabin monitoring system comprising:
a sensor disposed within an interior cabin of a vehicle equipped with the vehicular cabin monitoring system, wherein the sensor senses within the interior cabin of the vehicle;
an electronic control unit (ECU);
wherein sensor data captured by the sensor is transferred to the ECU;
wherein the ECU comprises electronic circuitry and associated software, and wherein the electronic circuitry of the ECU comprises a processor operable to process sensor data transferred to the ECU;
wherein the vehicular cabin monitoring system, via processing at the ECU of sensor data captured by the sensor, is operable to determine presence of an occupant within the interior cabin of the vehicle;
an informational display screen disposed at an exterior rearview mirror assembly of the vehicle, wherein the informational display screen, when electrically operated, displays an informational alert that is viewable exterior the vehicle;
wherein the informational display screen is disposed at least one selected from the group consisting of (i) at a mounting base of the exterior rearview mirror assembly and (ii) at a forward portion of a mirror casing of the exterior rearview mirror assembly; and
wherein the vehicular cabin monitoring system, based on determination that the vehicle is parked and no driver is present within the interior cabin of the vehicle, and responsive to determining presence of the occupant within the interior cabin of the vehicle, operates the informational display screen to display the informational alert that is viewable exterior the vehicle.

19. The vehicular cabin monitoring system of claim 18, wherein the informational alert comprises a message displayed at the informational display screen that is indicative of presence of the occupant within the interior cabin of the vehicle.

20. The vehicular cabin monitoring system of claim 18, wherein the sensor comprises at least one selected from the group consisting of (i) a camera, (ii) a radar sensor and (iii) an ultrasonic sensor, and wherein the sensor is accommodated by a mirror head of an interior rearview mirror assembly disposed within the interior cabin of the vehicle.
